(19) United States
(12) Patent Application Publication
(10) Pub. No.: US 2020/0219100 A1
(43) Pub. Date: Jul. 9, 2020

(54) CONDITIONAL PAYMENTS

(71) Applicant: Wells Fargo Bank, N.A., San Francisco, CA (US)

(72) Inventors: Wayne Barakat, Novato, CA (US); Ross M. Cavanaugh, Harrisburg, NC (US); Nathan B. Coles, El Cerrito, CA (US); Randy E. Furr, Charlotte, NC (US)

(21) Appl. No.: 14/985,717

(22) Filed: Dec. 31, 2015

(51) Int. Cl. G06Q 20/40

(52) U.S. Cl. CPC G06Q 20/405

(57) ABSTRACT

A conditional payment unit executing on one or more processors at a financial institution may receive payment instructions that specify one or more conditions for the conditional payment unit to transact a payment from a first party to a second party. The conditional payment unit may further receive one or more indications of whether the one or more conditions have been satisfied by one or more of the second party or a third party. In response to determining that the one or more conditions have been satisfied, the conditional payment unit may transact the payment from the first party to the second party.

### TECHNICAL FIELD

The disclosure relates to transaction of conditional payments.

### BACKGROUND

A financial institution may electronically transact payments between parties. For example, a payer may specify a payee and an amount of money to pay the payee, and the financial institution may transact the payment of specified amount of money from a financial account associated with the payer to a financial account associated with the payee. Electronic transaction of payments may be faster, more convenient, and more secure than via other methods of payment.

### SUMMARY

In general, this disclosure describes techniques for transacting payments upon satisfaction of one or more conditions. The financial institution may receive payment instructions that specify one or more conditional payments between parties that the financial institution may transact upon satisfaction of the one or more conditions. One or more computing devices of the financial institution may verify whether the one or more conditions have been satisfied and, upon verifying that the one or more conditions have been satisfied, transact the specified one or more payments between the specified parties.

To enable the financial institution to transact a payment upon satisfaction of one or more conditions, one or more computing devices of the financial institution may generate one or more rules based upon the payment instructions to govern such a conditional transfer of funds. The one or more computing devices may execute the one or more rules to govern the verification that the one or more conditions have been satisfied. The one or more computing devices may further execute the one or more rules to, upon satisfaction of the one or more conditions, transact the payment specified by the payment instructions. In this way, the rules engine executing the one or more rules may enable the financial institution to transact a payment upon satisfaction of one or more conditions.

For example, the payment instructions may specify a payer, a payee, and the amount of the payment from the payer to the payee. The payment instructions may further specify one or more conditions to be satisfied by a party other than the payer. The payer may communicate the payment instructions to a financial institution. The financial institution may be where the payer or the payee has a financial account (e.g., bank account, credit card account, etc.). One or more computing devices of the financial institution may generate one or more rules according to the payment instructions. The payee or a third party may communicate to the financial institution evidence that the one or more conditions have been satisfied. The financial institution may verify the received evidence and may, upon determining that the one or more conditions have been satisfied, transact the payment from the payer to the payee as specified by the payment instructions. In this way, the financial institution may automate a conditional payment without the need for the payer to monitor whether the one or more conditions for the conditional payment have been satisfied.

In one aspect, the disclosure is directed to a method for transacting a conditional payment. The method may include receiving, by a conditional payment unit executing on one or more processors, payment instructions that specify one or more conditions for the conditional payment unit to transact a payment from a first party to a second party. The method may further include receiving, by the conditional payment unit executing on the one or more processors, one or more indications of whether the one or more conditions have been satisfied by one or more of the second party or a third party. The method may further include in response to determining that the one or more conditions have been satisfied, transacting, by the conditional payment unit executing on the one or more processors, the payment from the first party to the second party.

In another aspect, the disclosure is directed to a system for transacting a conditional payment. The system may include one or more computing devices of the financial institution, the one or more computing devices comprising one or more processors configured to: receive payment instructions that specify one or more conditions for the conditional payment unit to transact a payment from a first party to a second party; receive one or more indications of whether the one or more conditions have been satisfied by one or more of the second party or a third party; and in response to determining that the one or more conditions have been satisfied, transact the payment from the first party to the second party.

In another aspect, the disclosure is directed to a non-transitory computer-readable medium that stores instructions. The instructions, when executed, cause one or more processors to: receive, by a conditional payment unit, payment instructions that specify one or more conditions for the conditional payment unit to transact a payment from a first party to a second party; receive, by the conditional payment unit, one or more indications of whether the one or more conditions have been satisfied by one or more of the second party or a third party; and in response to determining that the one or more conditions have been satisfied, transact, by the conditional payment unit, the payment from the first party to the second party.

The details of one or more aspects of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example payment transaction system that includes an example financial institution having an example conditional payment unit that is configured to perform conditional payment transactions between two or more parties, such as between an example payer, an example payee, and potentially one or more example third parties, in accordance with the techniques of this disclosure

FIG. 2 is a block diagram illustrating the example conditional payment unit of the example financial institution of FIG. 1 in greater detail.

FIG. 3 is a flowchart illustrating an example process for transacting conditional payments in accordance with the techniques of this disclosure.

### DETAILED DESCRIPTION

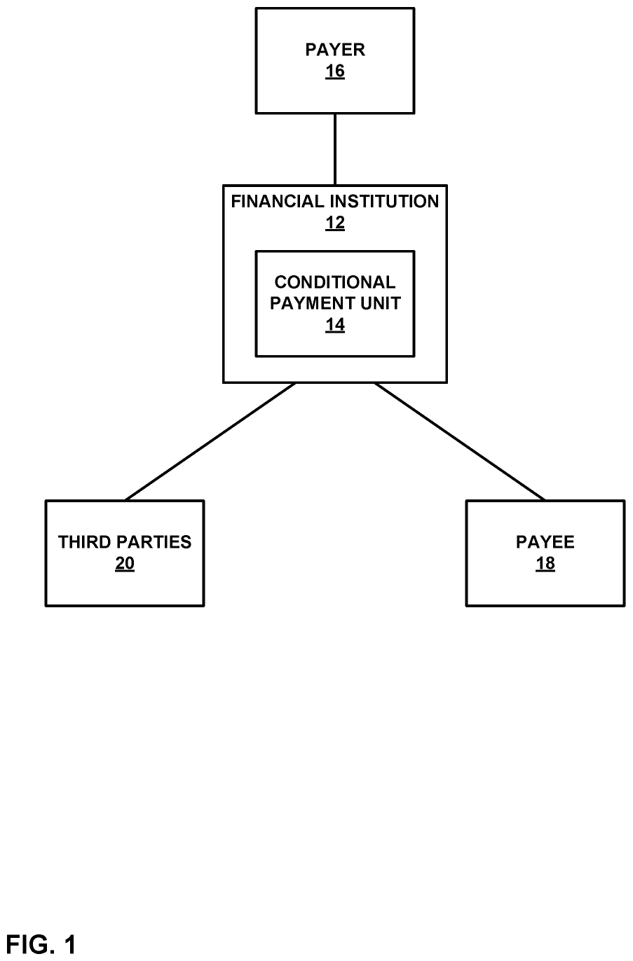

FIG. 1 is a block diagram illustrating an example payment transaction system that includes a financial institution 12 having a conditional payment unit 14 that is configured to perform conditional payment transactions between two or more parties, such as between a payer 16, a payee 18, and potentially one or more third parties 20, in accordance with the techniques of this disclosure. As described in more detail below, conditional payment unit 14 at financial institution 12 may be configured to transact payments from payer 16 to payee 18 upon determining that one or more conditions have been satisfied.

As shown in FIG. 1, the payment transaction system may comprise a plurality of computing devices at each of financial institution 12, payer 16, payee 18, and in some instances may also include one or more computing devices at one or more third parties 20. The one or more computing devices at each of financial institution 12, payer 16, payee 18, and one or more third parties 20 may include mainframe computers, desktop computers, laptops, workstations, automated teller machines, wireless devices, smart phones, tablet computers, smart watches, mobile computing devices, network-ready appliances, file servers, print servers, or other devices. The computing devices at each of financial institution 12, payer 12, payee 18, and one or more third parties 20 may communicate with each other via one or more networks, including one or more of a private network associated with financial institution 12 or a public network, such as the Internet.

Financial institution 12 may be a traditional bank or credit union, or any other suitable financial institution, with the capability of offering checking accounts, savings accounts, credit card accounts, and/or other financial accounts to its customers, such as one or more of payer 16, payee 18, and one or more third parties 20. While the term bank account may be used throughout this disclosure, it should be understood that this disclosure is not so limited to transacting payments between bank accounts of payer 16, payee 18, and one or more third parties 20. Instead, it should be understood that that the techniques of this disclosure are equally applicable to payment transactions between any combinations of suitable financial accounts, including but not limited to bank accounts, savings accounts, checking accounts, retirement accounts, credit card accounts, virtual currency accounts, and the like.

Financial institution 12 may include conditional payment unit 14. Conditional payment unit 14 may be configured to transact payments between two or more parties in response to determining that the one or more conditions for transacting the payments have been satisfied. Transacting payments between two or more parties may include transferring monetary funds between financial accounts (e.g., bank accounts, credit card accounts, and the like) associated with the two or more parties. Although illustrated as a single device, conditional payment unit 14 may comprise one or more computing devices. For example, conditional payment unit 14 may be a single computing device or a system of at least two computing devices. The one or more computing devices of conditional payment unit 14 may include mainframe, desktop computers, laptops, workstations, wireless devices, network-ready appliances, file servers, print servers, or other devices.

Conditional payment unit 14 may receive, from a party, payment instructions for transacting a conditional payment from payer 16 to payee 18. The payment instructions may specify one or more conditions to be satisfied by a party other than payer 16 in order for conditional payment unit 14 to transact a specified payment from payer 16 to payee 18. The one or more conditions may be satisfied by payee 18 or one or more third parties 20 by completing performance of one or more tasks. The payment instructions may specify a payer, such as payer 16, a payee, such as payee 18, one or more conditions to be satisfied by payee 18 or one or more third parties 20, and an amount of money that the payer is to pay payee in response to satisfaction of the one or more conditions.

For example, conditional payment unit 14 may receive payment instructions to transact a conditional payment from payer 16 to payee 18. The condition may be any of a variety of conditions. In one non-limiting example for purposes of illustration, the payment instructions may specify that conditional payment unit 14 is to transact a payment from payer 16 to payee 18 upon satisfaction of a condition that payee 18 earns straight A's in school for the current semester. Upon conditional payment unit 14 verifying that payee 18 has earned straight A's in school for the current semester, conditional payment unit 14 may transact the specified payment from payer 16 to payee 18.

In some examples, conditional payment unit 14 may receive the payment instructions that specify one or more conditions from payer 16. In other examples, conditional payment unit may receive the payment instructions from payee 18 or one or more third parties 20. If conditional payment unit 14 receives the payment instructions which proposes that payer 16 pays payee 18 from a party other than payer 16, payment unit 14 may require payer 16 to confirm and/or approve the payment instructions prior to processing of the payment instructions.

A party may submit payment instructions to conditional payment unit 14 in any number of ways. In one example, conditional payment unit 14 may provide a user interface, such as through a web page, an application (e.g., a mobile application), or the like, with which a party may interact to submit payment instructions. By submitting payment instructions that specify a conditional payment, the party programs conditional payment unit 14 to operate according to one or more rules to transact conditional payments according to the payment instructions.

Conditional payment unit 14 may process the payment instructions it receives by generating one or more rules based at least in part on the payment instructions. The one or more rules may govern conditional payment unit 14 with respect to if and when conditional payment unit 14 transacts payment from payer 16 to payee 18, based at least in part on the one or more conditions specified by the payment instructions being satisfied by payee 18 or one or more third parties 20. The one or more rules may also govern the verification of whether the one or more conditions have been satisfied, as well as transacting payment from payer 16 to payee 18 upon verifying that the one or more conditions have been satisfied.

Conditional payment unit 14 may associate the generated one or more rules with one or more of payer 16 or payee 18 specified by the payment instructions. If payee 18 has a bank account at financial institution 12, conditional payment unit 14 may associate the one or more rules with an account of payee 18 at financial institution 12. Alternatively, if payer 16 has an account at financial institution 12, conditional payment unit 14 may associate the one or more rules with the account of payer 16 at financial institution 12.

Conditional payment unit 14 may receive one or more indications of whether the one or more conditions specified by the payment instructions have been satisfied. For example, conditional payment unit 14 may provide a user interface, such as through a web page, an application (e.g., a mobile application), or the like, with which a party may interact to submit an indication that a condition has been satisfied. Conditional payment unit 14 may determine, based on the one or more indications of whether the one or more conditions have been satisfied, that the one or more conditions have been satisfied.

In the example discussed above, where the one or more conditions for transacting a payment from payer 16 to payee 18 may be satisfied if payee 18 earns straight A's in class in the current semester, conditional payment unit 14 may, at the end of the current semester, receive one or more indications of the grades of payee 18 for the semester. In one example, payee 18 or an educational institution attended by payee 18 may upload a copy of a report card to conditional payment unit 14 as an indication that payee 18 has satisfied the one or more conditions. Conditional payment unit 14 may determine, based at least in part on the uploaded report card, that the one or more conditions has indeed been satisfied. In another example, conditional payment unit 14 may communicate with computing devices associated with payee 18's school, such as a server that stores payee 18's grades in a database, to electronically receive one or more indications of payee 18's grades.

In response to determining that the one or more conditions specified by the payment instructions have been satisfied, conditional payment unit 14 may transact the payment specified by the payment instructions from payer 16 to payee 18. In the example where the one or more conditions for transacting a payment from payer 16 to payee 18 may be satisfied if payee 18 earns straight A's in class in the current semester, payment unit 14 may, in response to verifying that payee 18 has indeed earned straight A's in class in the current semester, transact the payment from payer 16 to payee 18 as specified by the payment instructions, such as by performing a withdraw of the funds from payer 16's bank account and depositing the funds into payee 18's bank account.

In this manner, financial institution 12 may provide payment services to transact payments from payer 16 to payee 18 that are contingent upon fulfillment of one or more conditions by a party other than payer 16. By operating according to a set of rules generated based at least in part on the one or more conditions specified by payment instructions, conditional payment unit 14 may enable the processing of conditional payments from payer 16 to payee 18, as well as other complex multi-party conditional payments, without requiring payer 16 to continuously monitor whether the one or more conditions specified by the patent instructions have been satisfied.

Further, because conditional payment unit 14 may determine whether the one or more conditions have been satisfied without receiving input from payer 16, the techniques described in this disclosure may potentially improve the functioning of the computer upon which conditional payment unit 14 executes by requiring fewer inputs to be received in order to transact conditional payments, thereby enabling the computer to more quickly and efficiently process conditional payments between parties.

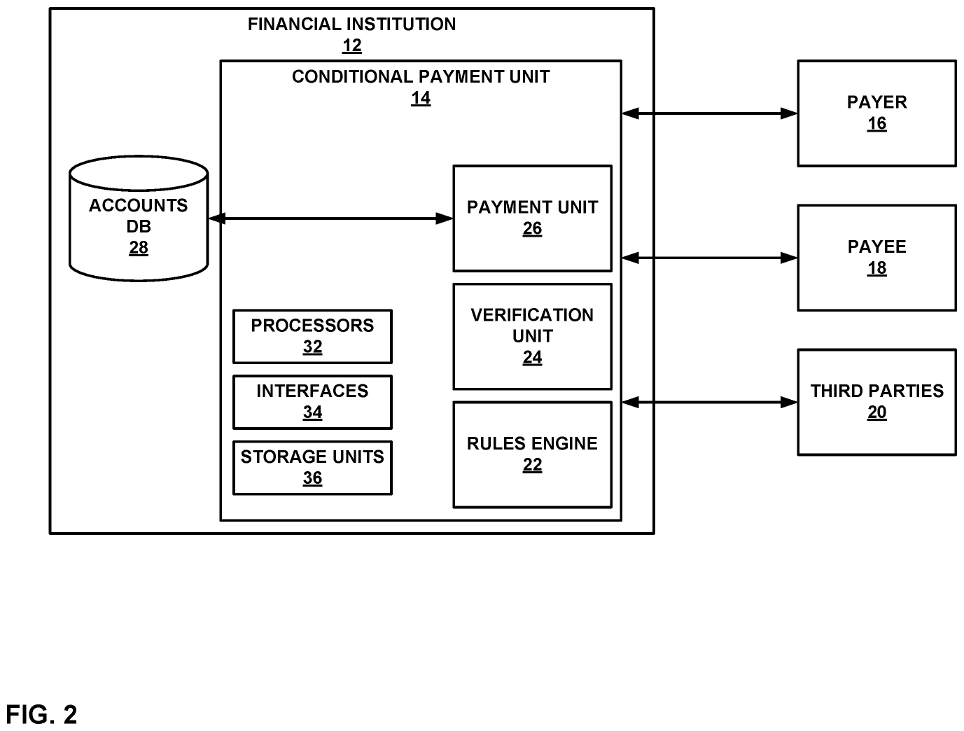

FIG. 2 is a block diagram illustrating conditional payment unit 14 of financial institution 12 of FIG. 1 in greater detail. As shown in FIG. 2, financial institution 12 may include accounts database 28 and conditional payment unit 14. Accounts database 28 may store accounts details of customers who maintain a financial account at financial institution 12. For example, accounts database 28 may store accounts details of one or more of payer 16, payee 18, and one or more third parties 20.

Conditional payment unit 14 may include rules engine 22, verification unit 24, and payment unit 26. In addition, conditional payment unit 14 may also include one or more processors 32, one or more interfaces 34, and one or more storage units 36. Rules engine 22, verification unit 24, and payment unit 26 may be executable by processors 32 or implemented as one or more hardware units of conditional payment unit 14. The architecture of conditional payment unit 14 illustrated in FIG. 2 is shown for exemplary purposes only and conditional payment unit 14 should not be limited to this architecture. In other examples, conditional payment unit 14 may be configured in a variety of ways.

Although not shown in FIG. 2, each of the components, units or modules of conditional payment unit 14 are coupled (physically, communicatively, and/or operatively) using communication channels for inter-component communications. In some examples, the communication channels may include a system bus, a network connection, an inter-process communication data structure, or any other method for communicating data.

Processors 32, in one example, are configured to implement functionality and/or process instructions for execution within conditional payment unit 14. For example, processors 32 may be capable of processing instructions stored by storage units 36. Processors 32 may include, for example, microprocessors, digital signal processors (DSPs), application specific integrated circuits (ASICs), field-programmable gate array (FPGAs), or equivalent discrete or integrated logic circuitry.

Conditional payment unit 14 may utilize interfaces 34 to communicate with external devices via one or more wired or wireless connections. In some examples, check processing device 18 utilizes interfaces 34 to communicate with external devices such as payments database 27 maintained by financial institution 12, as well as external devices at payer 16, payee 18, and/or one or more third parties 20. Interfaces 34 may be universal serial bus (USB) interfaces, optical interfaces, or network interfaces cards, or any other type of interfaces capable of sending and receiving information. Examples of such network interfaces may include Ethernet, Wi-Fi, or Bluetooth radios, and the like.

Storage units 36 may store an operating system (not shown) that controls the operation of components of conditional payment unit 14. For example, the operating system may facilitate the communication of rules engine 22, verification unit 24, and payment unit 26 with processors 32, interfaces 34, and storage units 36. In some examples, storage units 36 are used to store program instructions for execution by processors 32. Storage units 36 may also be configured to store information within conditional payment unit 14 during operation. Storage units 36 may be used by software or applications (e.g., rules engine 22, verification unit 24, and payment unit 26) running on processors 32 of conditional payment unit 14 to temporarily store information during program execution.

Storage units 36 may include a computer-readable storage medium or computer-readable storage device. In some examples, storage units 36 include one or more of a short-term memory or a long-term memory. Storage units 36 may include, for example, random access memories (RAM), dynamic random access memories (DRAM), static random access memories (SRAM), magnetic hard discs, optical discs, floppy discs, flash memories, or forms of electrically programmable memories (EPROM) or electrically erasable and programmable memories (EEPROM).

According to aspects of this disclosure, conditional payment unit 14 may be configured to receive payment instructions that specify one or more conditions to be satisfied for a first party, such as payee 18, to receive payment from a second party, such as payer 16, receive one or more indications of whether the one or more conditions have been satisfied, and, in response to determining, based at least in part on the one or more indications of whether the one or more conditions have been satisfied, that the one or more conditions have been satisfied, transact the payment from the second party, such as payer 16, to the first party, such as payee 18.

In some examples, conditional payment unit 14 may receive payment instructions from payer 16, payee 18, or one or more third parties 20. The payment instructions may specify one or more conditions for payee 18, to receive payment from payer 16. Rules engine 22 may generate one or more rules that govern the transaction of the payment from payer 16 to payee 18. Verification unit 24 may verify that the one or more conditions have been satisfied. Payment unit 26 may transact the payment from payer 16 to payee 18.

The payment instructions received by conditional payment unit 14 may specify payments from a first party to a second party. For example, the payment instructions may specify payments from payer 16 to payee 18, from payee 18 to payer 16, and/or payments from one or more third parties to payer 16 or payee 18. In some examples, the payment instructions may specify multiple payments that may each be associated with one or more conditions.

The one or more conditions may be one or more conditions to be satisfied by a party other than payer 16. For example, the one or more conditions may be satisfied by payee 18. The one or more conditions may also include one or more conditions to be satisfied by one or more third parties 20. For example, if payer 16 purchases a product from payee 18 that is delivered by a third party, the one or more conditions for payer 16 to pay payee 18 may include successful delivery of the purchased product by the third party to payer 16.

The one or more conditions to be satisfied may include completion of one or more tasks by a party other than payer 16. Such tasks may be unrelated to any interactions with financial institution 12 (e.g., payee 18 submitting to financial institution 12 an indication that she accepts the payment from payer 16) or the performance by payee 18 of any financial transactions. For example, if payer 16 purchases a home appliance (e.g., a water heater) from payee 18 (e.g., a home appliance store), the one or more conditions for payer 16 to pay payee 18 may include completion of installation of the water heater into payer 16's home. In other examples, the one or more conditions to be satisfied may also include completion of one or more tasks by payee 18. In the example discussed above, payee 18 receiving straight A's may be a condition that must be completed by payee 18.

The one or more conditions to be satisfied may include multiple conditions that are to be satisfied. For example, payer 16 may specify that payer 16 is to pay payee 18 if payee 18 gets straight A's in school and if payee 18 has perfect attendance at school. In this example, payee 18 may have to satisfy both conditions in order for conditional payment unit 14 to transact a payment from payer 16 to payee 18.

In some examples, the payment instructions may specify that the specified conditional payments occur on a recurring basis. The payment instructions may specify a recurring time period, such as every week, every month, and every year, in which a specified payment may be transacted upon satisfaction of the one or more conditions. For example, the payment conditions may specify that payer 16 is to pay payee 18 upon payee 18 receiving straight A's each quarter of the school year. In this example, at the end of each quarter of the school year, conditional payment unit 14 may verify whether payee 18 has received straight A's for that quarter, and, upon verification, may transact a payment from payer 16 to payee 18.

In another example, if payer 16 buys a water heater that is manufactured by payee 18, the payment instructions may specify that payer 16 is to pay payee 18 a predetermined amount (e.g., ten dollars) each month if payer 16's monthly electricity bill is under a specified amount (e.g., fifty dollars). In this example, at the end of each month, conditional payment unit 14 may verify whether payer 16's electricity bill for the month is indeed under the specified amount and, if so, may transact a payment of the predetermined amount from payer 16 to payee 18.

In addition to transacting payments between payer 16 and payee 18, the payment instructions may also specify one or more additional actions that conditional payment unit 14 may take upon verifying satisfaction of the one or more conditions. Specifically, the payment instructions may specify that conditional payment unit 14 perform one or more additional actions that do not include transacting payments between parties upon verifying satisfaction of the one or more conditions. In an example where the payment instructions specify that payer 16 is to pay payee 18 upon the completion of the installation of a water heater to payer 16's home, the payment instructions may further specify that conditional payment unit 14, upon verifying that the water heater has been installed into payer 16's home, perform additional actions such as registering the water heater with the manufacturer of the water heater, or to schedule a water heater maintenance company to inspect the water heater in a year's time.

Conditional payment unit 14 may provide a user interface, such as via a website, a mobile app, and the like, that is accessible by payer 16, payee 18, and/or one or more third parties 20 to submit payment instructions to conditional payment unit 14. Payer 16 may interact with the user interface presented by conditional payment unit 14 to input payment instructions that specifies one or more conditions for payee 18 to receive payment from payer 16. Payer 16 may, via the presented user interface, specify a conditional payment from payer 16 to payee 18, and may specify one or more conditions for conditional payment unit 14 to transact the payment from payer 16 to payee 18. For example, payer 16 may specify the payer (e.g., payer 16), the payee (e.g., payee 18), the payment amount, payer 16's bank account information from which the payment may be withdrawn, and payee 18's bank account information to which the payment may be deposited, and one or more conditions for transacting the payment from payer 16 to payee 18.

Conditional payment unit 14 may present a set of pre-determined conditions in the user interface that payer 16 may select, modify, or with which to interact to specify one or more conditions for transacting the payment from payer 16 to payee 18. For example, the conditions may be presented in a drop-down menu that payer 16 may select. Payer 16 may finalize and submit the payment instructions via the provided user interface.

Payer 16 may also enter one or more conditions via natural language (e.g., English), via a programming or scripting language as one or more conditional statements (e.g., if-then statements), or via any other suitable method. Alternatively, payee 18 or one or more third parties may, in lieu of or in addition to payer 16, communicate to conditional payment unit 14 a rule for a conditional payment from payer 16 to payee 18. For example, similar to the example presented above, payee 18 or one or more third parties 20 may interact with the user interface presented by conditional payment unit 14 to configure one or more conditions for transacting a payment from payer 16 to payee 18. Conditional payment unit 14 may communicate the proposed payment instructions to payee 18 and/or one or more third parties 20 for confirmation and/or verification. For example, conditional payment unit 14 may send a message, such as a text message, an e-mail, and the like to payee 18 alerting payer 18 of the payment instructions submitted by payer 16. The message may include details of the proposed payment instructions and a link to a web page where payee 18 may review and either approve, decline, or modify the proposed payment instructions.

If conditional payment unit 14 receives payment instructions for a conditional payment by payer 16 to payee 18 from a party other than payer 16, conditional payment unit 14 may communicate the proposed payment instructions to payer 16 for confirmation and/or verification. For example, conditional payment unit 14 may send a message, such as a text message, an e-mail, and the like to payer 16 alerting payer 16 of the proposed payment instructions. The message may include details of the proposed payment instructions and a link to a web page where payer 16 may review and either approve, decline, or modify the proposed payment instructions.

In some examples, conditional payment unit 14 may associate payment instructions with certain financial transactions made at financial institution 12. For example, if payer 16 uses a credit card issued by financial institution 12 to purchase a product from an online retailer that is to be shipped to payer 16, conditional payment unit 14 may associate payment instructions with the credit card purchase. Specifically, when the online retailer communicates an indication of such a purchase to financial institution 12, conditional payment unit 14 may associate with the purchase payment instructions that specify a conditional payment from payer 16's credit card account to the online retailer upon confirmation of delivery of the purchased product.

Upon confirmation of the payment instructions, rules engine 22 of conditional payment unit 14 may generate one or more rules governing the transaction of the conditional payment from payer 16 to payee 18 according to the information specified by the payment instructions. For particular payment instructions that specify one or more conditions, rules engine 22 may generate corresponding one or more rules that enable payment unit 26 to transact the payment specified by the payment instructions upon verification unit 24 verifying satisfaction of the one or more conditions.

Rules engine 22 may operatively communicate with verification unit 24 to receive from verification unit 24 one or more indications that verification unit 24 has verified satisfaction of the one or more conditions specified by the payment instruction. In response to receiving one or more indications that verification unit 24 has verified satisfaction of the one or more conditions, rules engine 22 may operatively communicate to payment unit 26 one or more indications that the one or more conditions have been satisfied. Payment unit 26 may, in response to receiving the one or more indications that the one or more conditions have been satisfied, transact the payment specified by the payment instructions.

Verification unit 24 of conditional payment unit 14 may be configured to verify whether the one or more conditions specified by the payment instructions have been satisfied. Verification unit 24 may receive evidence that verifies satisfaction of the one or more conditions specified by the payment instructions. One example of evidence that verifies satisfaction of the one or more conditions specified by the payment instructions may include one or more electronic documents that are uploaded to conditional payment unit 14 that indicate whether the one or more conditions have been satisfied.

Such electronic documents may, in one example, be scanned copies of physical documents that indicate whether the one or more conditions have been satisfied. In the example where payer 16 issues payment instructions which specify that conditional payment unit 14 is to transact a payment from payer 16 to payee 18 upon satisfaction of a condition that payee 18 earns straight A's in school for the current semester, payee 16 may scan her report card for the current semester and may upload the scanned report card to conditional payment unit 14 for verification. In some examples, one or more third parties 20, such as the school issuing the report card, may upload a copy of payee 18 to conditional payment unit 14 in lieu of payee 18. In this example, the one or more conditions may be one or more conditions to be satisfied by the payee 18: that payee 18 earns straight A's in school.

Verification unit 24 may verify the one or more electronic documents it receives to determine whether the one or more conditions have been satisfied. In the example of a scanned report card, verification unit 24 may perform optical character recognition to verify that the report card is reporting the grades of payee 18, is a report card for the current semester, and that the grades specified by the report card meets the condition of being straight A's. In other examples, verification unit 24 may present the electronic document to a user, such as an employee or contractor of financial institution 12, who can review the one or more electronic documents received by verification unit 24, and who may provide an indication to verification unit 24 whether the one or more conditions have been satisfied based on their review of the one or more electronic documents.

Verification unit 24 may also communicate with one or more third parties 20 to receive, from the one or more third parties 20, evidence that verifies satisfaction of the one or more conditions. One or more third parties 20 may include parties other than payer 16 and payee 18 that may have information useful in verifying whether one or more conditions specified by the payment instructions have been satisfied.

One or more third parties 20 may be computers, servers, and the like that may communicate electronically with verification unit 24 to provide one or more indications of whether the one or more conditions have been satisfied. In one example where payer 16 purchases a water heater from payee 18, payment instructions may specify that payer 16 is to pay payee 18 upon successful installation of the water heater into payer 16's home. In this example, the condition specified by the payment instructions may comprise the completion of a task: the installation of the water heater into payer 16's home. Further, the condition specified by the payment instructions may include a condition that is satisfied by one or more third parties 20, such as the plumbing company that installs the water heater.

Verification unit 24 may determine successful completion of the installation of the water heater into payer 16's house based at least in part on whether the water for payer 16's home was shut off, thereby indicating the start of installing the water heater, and then turned back on, thereby indicating the completion of installing the water heater.

Verification unit 24 may communicate, via a network such as the Internet, with the utility company that provides water to payer 16's house to determine if and when water serve was shut off and turned back on at payer 16's house. For example, verification unit 24 may communicate a request to the utility company to send indications that the water at payer 16's house is turned off and turned back on. When the water at payer 16's house is turned off, verification unit 24 may receive an indication from the utility company that the water at payer 16's house is turned off. Similarly, when the water at payer 16's house is turned back on after being turned off, verification unit 24 may receive an indication from the utility company that the water at payer 16's house is turned back on. Upon receiving indications that the water at payer 16's house is turned off and that the water at payer 16's house is turned back on, verification unit 24 may determine that the water heater has been successfully installed into payer 16's home, and that the one or more conditions specified by the payment instructions have been satisfied.

Upon determining that the one or more conditions specified by the payment instructions have been satisfied, verification unit 24 may communicate to payment engine 26 an indication that the one or more conditions specified by the payment instructions have been satisfied. Rules engine 22 may also direct payment engine 26 to transact one or more payments based on the one or more rules generated by rules engine 22 based at least in part on the payment instructions. Payment engine 26 may, upon receiving such an indication from verification unit 24, may transact payments according to the payment instructions. For example, if the payment instructions specify a payment amount from payer 16 to payee 18 upon satisfaction of the one or more conditions, payment engine 26 may transfer the specified payment account from payer 16's bank account into payee 18's bank account.

In some examples, payer 16 may issue payment instructions to conditional payment unit 14 to coordinate complex, multi-party conditional payments. For example, payer 16 may issue payment instructions that specify multiple payments that may each be associated with one or more conditions. For example, the payment instructions may specify a first payment from payer 16 to payee 18 upon satisfaction of a first set of one or more conditions, and may further specify a second payment from payer 16 to one or more third parties 20 upon satisfactions of a second set of one or more conditions.

In one example, if payer 16 is a consumer who purchases a water heater from payee 18 (e.g., a retail store that sells the water heater), payer 16 may issue payment instructions that includes a first conditional payment, where payer 16 may pay payee 18 upon installation of the water heater into payer 16's home. In addition, payer 16 may further include in the payment instructions a second conditional payment, where payer 16 may pay the manufacturer of the water heater (e.g., one or more third parties 20) a specified amount of money if payer 16's monthly electricity bills decrease by more than 10% year-over-year after installation of the water heater. Thus the conditions specified by payment instructions may not simply be the performance or completion of a task by payer 16 or one or more third parties 20. Instead, payment instructions may also specify conditions that are benefits received by payer 16 or one or more third parties 20.

In this example, verification unit 24 may verify that the first and second conditions have been satisfied by receiving evidence of satisfaction of the first and second conditions from a plurality of different parties. As discussed above, verification unit 24 may receive, from the water company that provides water to payer 16's house, an indication of whether the water heater was installed. The indication may include an indication that the water at payer 16's house is turned off and turned back on. Further, verification unit 24 may receive, from the electric company that provides electricity to payer 16's house, an indication of whether payer 16's monthly electricity bills decrease by more than 10% year-over-year after installation of the water heater. For example, the indication may include the historical electricity bills of payer 16 that verification unit 24 may analyze to determine whether the second condition has been satisfied.

Upon verifying the satisfaction of the first condition, payment unit 26 may transact the specified conditional payment associated with satisfaction of the first condition. Similarly, upon verifying satisfaction of the second condition, payment unit 26 may transact the specified conditional payment associated with satisfaction of the second condition. For example, if both payer 16 and payee 18 maintain an account at financial institution 12, payment unit 26 may communicate with accounts DB 28 to transfer funds out of payer 16's account and into payee 18's account.

In another example, conditional payment unit 14 may transact partial payments over a specified period of time. Conditional payment unit 14 may receive payment instructions that specify partial payments and/or time-based payments, and may periodically verify one or more conditions to periodically transact payments according to the payment instructions.

In one example, payer 16 may issue payment instructions to conditional payment unit 14 that specify multiple partial payments over a period of time to a specified payee 18 that may be associated with satisfaction one or more conditions. The payment instructions may specify that the periodic partial payments are to commence upon satisfaction of a first one or more conditions, and may further specify that the periodic partial payments are to be transacted by conditional payment unit 14 upon periodic satisfaction of a second one or more conditions.

For example, payer 16 may pay for the purchase of a product by making partial payments over a period of time, such as monthly payments over a period of multiple months. If the product purchased by payer 16 requires installation, payer 16 may issue payment instructions that specify that payer 16 is to make periodic payments over a specified period of time to payee 18.

The payment instructions may include a condition of completing installation of the product that may be satisfied prior to commencing the periodic payments. In one example, verification unit 24 may verify that a product (e.g., a high efficiency air conditioner) has been installed. For example, a heating, ventilation, and air conditioning (HVAC) company that installs the air conditioner, payee 16, or one or more third parties 20 may send an indication to financial institution 12 that such party has completed installation of the air conditioner. In response to verifying that the air conditioner has been installed, conditional payment unit 14 may transact one or more payments to payee 18 (e.g., HVAC company or another retailer from which payee 16 purchased the air conditioner) according to the payment instructions.

The payment instructions may also specify that payer 16 is to transact partial payments over a specified period of time to payee 18. Thus, in the example described above, upon verifying that the air conditioner has been installed, conditional payment unit 14 may commence periodic partial payments to payee 18 over a specified period of time according to the payment instructions. Such periodic payments may be, in some examples, per week, per month, per year, and the like. For example, the payment instructions may specify that payee 16 is to pay 10% of the price of the air conditioner each month for ten months. Thus, upon verifying that the air conditioner has been installed, payment unit 26 may transact the first partial payment of 10% of the price of the air conditioner from payer 16 to payee 18. Payment unit 26 may continue to transact partial payments on a monthly basis from payer 16 to payee 18 according to the payment instructions, until payer 16 has transacted 100% of the purchase price of the air conditioner to payee 18.

Conditional unit 14 may include a computing module, a computer process, or the like that may be configured to periodically transact payments from payer 16 to payee 18 according to the payment instructions. For example, if payment instructions specify a particular day of the month (e.g., the first day of the month, the last day of the month, the first Friday of the month, and the like) on which to transact each of the periodic payments, conditional unit 14 may determine whether the particular day has arrived based on an internal timing module, calendar unit, and the like. Upon determining that the specified day has arrived, payment unit 26 may transact the specified periodic payment from payer 16, to payee 18.

The payment instructions may further specify one or more conditions that are to be satisfied for conditional payment unit 14 to transact one or more of the periodic partial payments from payer 16 to payee 18. The payment instructions may specify that each one of the periodic partial payments is contingent on satisfaction of one or more periodic conditions.

For example, with respect to the air conditioner example from above for purposes of illustration, each of the monthly partial payments for the air conditioner may be contingent upon energy savings (e.g., a reduction in payer 16's electricity bill by a specified amount of money or a specified percentage of savings) for the month by payer 16. At the specified date for transacting a partial payment (e.g., at a particular day of the month in the case of a month payment), verification unit 24 may communicate with payer 16's power company (i.e., one or more third parties 20) to determine payer 16's electricity bill for the month, and may compare payer 16's electricity bill with, for example, payer 16's electricity bill for the same month in previous years to verify whether payer 16's electricity bill is lower than payer 16's historical electricity bills for the month in past years by the specified amount.

Upon verifying that the savings on payer 16's electricity bill has met the specified requirements of the payment instructions, payment unit 26 may transact all of the partial payment for that month from payer 16 to payee 18. If verification unit 24 determines that the savings on payer 16's electricity bill has not met the specified requirements of the payment instructions, payment unit 26 may transact a portion of the partial payment (e.g., a sum of money that is less than the entirety of the partial payment for the month) from payer 16 to payee 18 as specified in the payment instructions, or may withhold payment altogether according to the payment instructions.

Conditional payment unit 14 may also receive payment instructions that specify partial payments and/or time-based payments that may include multi-way (e.g., two-way) periodic payments. In multi-way periodic payments, payment instructions may specify that conditional payment unit 14 may transact periodic payments that may flow from payer 16 to payee 18 as well as payee 18 to payer 16 based at least in part on satisfaction of one or more conditions.

For example, payer 16 may pay payee 18 on a periodic basis (e.g., on a weekly, monthly, yearly or other basis) to maintain payer 16's air conditioning equipment on the condition that payee 18 keeps the air conditioning equipment operational, as confirmed by one or more third parties 20 (e.g., the electricity company). However, if the air conditioning equipment stops operating, payer 16 may withhold payments to payee 18 or may require payee 18 to pay payer 16 a penalty.

In this example, conditional payment unit 14 may receive payment instructions that specify that payer 16 is to pay payee 18 each month upon satisfying the condition that payer 16's air conditioning equipment runs continuously for each month where payer 16 is to pay payee 18. The payment instructions may further specify that if the condition is not satisfied for each month where payer 16 is to pay payee 18, payee 18 is to pay payer 16 a specified penalty. Thus, at each month, verification unit 24 may communicate with payer 16's electricity company to receive an indication of whether payer 16's air conditioning equipment was running continuously in the past month.

If verification unit 24 determines that payer 16's air conditioning equipment was running continuously in the past month, thereby satisfying the condition specified in the payment instructions, payment unit 26 may transact a payment from payer 16 to payee 18 as specified in the payment instructions. Conversely, if verification unit 24 determines that payer 16's air conditioning equipment did not run continuously in the past month, thereby not satisfying the condition specified in the payment instructions, payment unit 26 may instead transact a payment from payee 18 to payer 16 as specified in the payment instructions. Conditional payment unit 22 may periodically re-determine on a month basis whether payer 16's air conditioning equipment ran continuously in the past month according to the payment instructions to transact future period payments between payer 16 and payee 18 according to the payment instructions.

Besides transacting payment upon verification of satisfaction of the one or more conditions, conditional payment unit 14 may, upon verification of satisfaction of the one or more conditions, perform one or more additional actions unrelated to transacting payments. For example, conditional payment unit 14 may persist a history of payments between payer 14 and payee 18 into a historical payments database that conditional payment unit 14 persists on storage units. Conditional payment unit 14 may also register a product purchased by payer 14 with the manufacturer for warranty purposes. In this way, conditional payment unit 14 may further automate additional actions that are associated with the payment instructions and the one or more conditions.

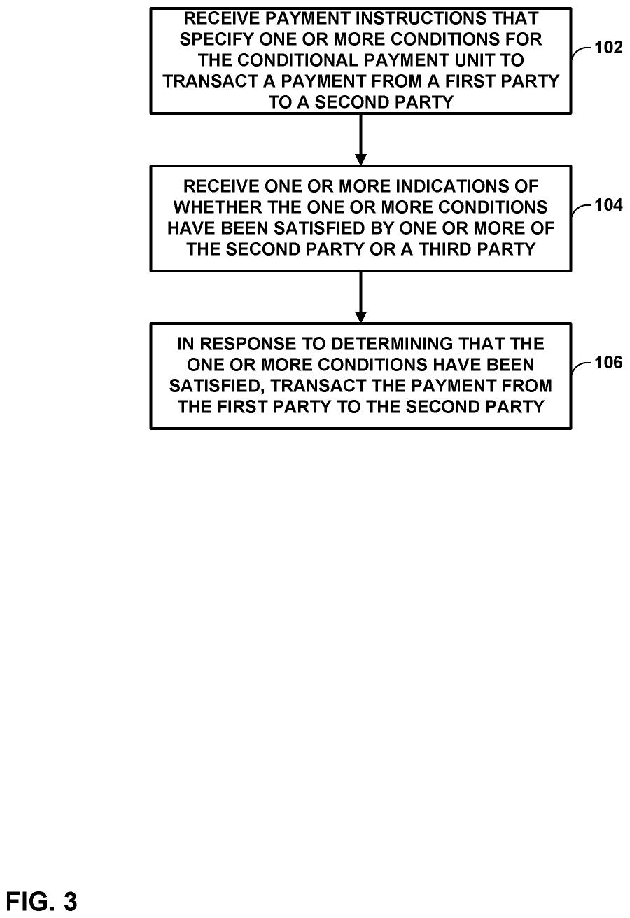

FIG. 3 is a flowchart illustrating an example process for transacting conditional payments in accordance with the techniques of this disclosure. As shown in FIG. 3, the process may include receiving, by conditional payment unit 14 executing on one or more processors 32, payment instructions that specify one or more conditions for the conditional payment unit to transact a payment from a first party (e.g., payer 16) to a second party (e.g., payee 18) (102). The process may further include receiving, by conditional payment unit 14 executing on the one or more processors 32, one or more indications of whether the one or more conditions have been satisfied by one or more of the second party or a third party (e.g., one or more third parties 20) (104). The process may further include, in response to determining, by conditional payment unit 14 executing on the one or more processors 32 that the one or more conditions have been satisfied, transacting, by conditional payment unit 14 executing on the one or more processors 32, the payment from the first party to the second party (104).

In some examples, the one or more conditions may include one or more tasks to be completed by one or more of the second party or the third party. In some examples, the one or more conditions may include one or more benefits received by the first party.

In some examples, the process may include receiving the one or more indications of whether the one or more conditions have been satisfied may include: receiving, by conditional payment unit 14 executing on the one or more processors 32, evidence of satisfaction of the one or more conditions by one or more of the second party or the third party, and verifying, by conditional payment unit 14 executing on the one or more processors 32, the evidence of satisfaction of the one or more conditions by one or more of the second party or the third party. In some examples, receiving the evidence of satisfaction of the one or more conditions by one or more of the second party or the third party may further include receiving, by conditional payment unit 14 executing on the one or more processors 32 from the third party, evidence of satisfaction of the one or more conditions by the second party.

In some examples, the payment instructions may further specify a second one or more conditions for conditional payment unit 14 to transact a second payment from the first party to the third party. In some examples, the process may further include generating, by conditional payment unit 14 executing on the one or more processors 32 and based at least in part on the payment instructions, one or more rules that govern transaction of the payment by the conditional payment unit from the first party to the second party

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over a computer-readable medium as one or more instructions or code, and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry, as well as any combination of such components. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a microprocessor, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples of the disclosure have been described. These and other examples are within the scope of the following claims.

1. A method for transacting a conditional payment, the method comprising:
receiving, by a conditional payment unit executing on one or more processors, payment instructions that specify a first party having an account, a second party, one or more conditions for the conditional payment unit to transact a payment from the account of the first party to the second party, and an amount of the payment, wherein the one or more conditions comprise a first set of one or more tasks to be completed by the second party and a second set of one or more tasks to be completed by a third party;
generating, by the conditional payment unit and based at least in part on the payment instructions, one or more rules that govern the transaction of the payment by the conditional payment unit from the account of the first party to the second party and one or more rules that govern the verification of evidence of satisfaction of the one or more conditions;
sending, by the conditional payment unit, a first request to the second party to send evidence of completion of the first set of one or more tasks and a second request to the third party to send evidence of completion of the second set of one or more tasks;
receiving, by the conditional payment unit, evidence of completion of the first set of one or more tasks by the second party and evidence of completion of the second set of one or more tasks by the third party;
verifying, by the conditional payment unit and based on the one or more rules that govern the verification of evidence of satisfaction, the evidence of completion of the first set of one or more tasks by the second party and the evidence of completion of the second set of one or more tasks by the third party;
determining, by the conditional payment unit, that the one or more conditions have been satisfied;
in response to determining that the one or more conditions have been satisfied, transacting, by the conditional payment unit and based on the one or more rules that govern the transaction of the payment, the payment from the account of the first party to the second party; and
in response to transacting the payment, storing, by the conditional payment unit, a history of the verification of the evidence of satisfaction of the one or more conditions and the transaction of the payment.

2. (canceled)

3. The method of claim 1, wherein the one or more conditions comprises one or more benefits to be received by the first party.

4. (canceled)

5. (canceled)

6. The method of claim 1, wherein the payment instructions further specify a second one or more conditions for the conditional payment unit to transact a second payment from the first party to the third party.

7. (canceled)

8. A system for transacting a conditional payment, the system comprising:
one or more computing devices of the financial institution, the one or more computing devices comprising one or more processors configured to:
receive payment instructions that specify a first party having an account, a second party, one or more conditions for the conditional payment unit to transact a payment from the account of the first party to the second party, and an amount of the payment, wherein the one or more conditions comprise a first set of one or more tasks to be completed by the second party and a second set of one or more tasks to be completed by a third party;
generate, based at least in part on the payment instructions, one or more rules that govern the transaction of the payment from the account of the first party to the second party and one or more rules that govern the verification of evidence of satisfaction of the one or more conditions;
send a first request to the second party to send evidence of completion of the first set of one or more tasks and a second request to the third party to send evidence of completion of the second set of one or more tasks;
receive evidence of completion of the first set of one or more tasks by the second party and evidence of completion of the second set of one or more tasks by the third party;
verify, based on the one or more rules that govern the verification of evidence of satisfaction, the evidence of completion of the first set of one or more tasks by the second party and the evidence of completion of the second set of one or more tasks by the third party;
determine that the one or more conditions have been satisfied;
in response to determining that the one or more conditions have been satisfied, transact, based on the one or more rules that govern the transaction of the payment, the payment from the account of the first party to the second party; and
in response to transacting the payment, store a history of the verification of the evidence of satisfaction of the one or more conditions and the transaction of the payment.

9. (canceled)

10. The system of claim 8, wherein the one or more conditions comprises one or more benefits to be received by the first party.

11. (canceled)

12. (canceled)

13. The system of claim 8, wherein the payment instructions further specify a second one or more conditions for the conditional payment unit to transact a second payment from the first party to the third party.

14. (canceled)

15. A non-transitory computer-readable medium storing instructions that, when executed, cause one or more processors to:
receive, by a conditional payment unit, payment instructions that specify a first party having an account, a second party, one or more conditions for the conditional payment unit to transact a payment from the account of the first party to the second party, and an amount of the payment, wherein the one or more conditions comprise a first set of one or more tasks to be completed by the second party and a second set of one or more tasks to be completed by a third party;
generate, by the conditional payment unit and based at least in part on the payment instructions, one or more rules that govern the transaction of the payment by the conditional payment unit from the account of the first party to the second party and one or more rules that govern the verification of evidence of satisfaction of the one or more conditions;
send, by the conditional payment unit, a first request to the second party to send evidence of completion of the first set of one or more tasks and a second request to the third party to send evidence of completion of the second set of one or more tasks;
receive, by the conditional payment unit, evidence of completion of the first set of one or more tasks by the second party or the first third party and evidence of completion of the second set of one or more tasks by the second third party;
verify, by the conditional payment unit and based on the one or more rules that govern the verification of evidence of satisfaction, the evidence of completion of the first set of one or more tasks by the second party and the evidence of completion of the second set of one or more tasks by the third party;
determine, by the conditional payment unit, that the one or more conditions have been satisfied;
in response to determining that the one or more conditions have been satisfied, transact, by the conditional payment unit and based on the one or more rules that govern the transaction of the payment, the payment from the account of the first party to the second party; and
in response to transacting the payment, store, by the conditional payment unit, a history of the verification of the evidence of satisfaction of the one or more conditions and the transaction of the payment.

16. (canceled)

17. The non-transitory computer-readable medium of claim 15, wherein the one or more conditions comprises one or more benefits to be received by the first party.

18. (canceled)

19. (canceled)

20. The non-transitory computer-readable medium of claim 15, wherein the payment instructions further specify a second one or more conditions for the conditional payment unit to transact a second payment from the first party to the third party.

21. (canceled)
